(19) United States
(12) Patent Application Publication
(10) Pub. No.: US 2018/0079632 A1
(43) Pub. Date: Mar. 22, 2018

(54) INDUSTRIAL TRUCK WITH MULTI-PART VEHICLE FRAME

(71) Applicant: Jungheinrich Aktiengesellschaft, Hamburg (DE)

(72) Inventors: Dominik Plachta, Oersdorf (DE); Emanuel Alber, Munchen (DE); Franz Wionzeck, Landshut (DE); Daniel Münch, Waldheim (DE)

(73) Assignee: Jungheinrich Aktiengesellschaft, Hamburg (DE)

(21) Appl. No.: 15/709,646

(22) Filed: Sep. 20, 2017

(30) Foreign Application Priority Data
Sep. 20, 2016 (CN) 201610833556.8

(51) Int. Cl. B66F 9/075

(52) U.S. Cl. CPC B66F 9/07513; B66F 9/22; B66F 9/07531; B66F 9/07554

(57) ABSTRACT

An industrial truck with a multi-part vehicle frame comprises a base portion comprising a front wall, a back wall disposed opposite the front wall, and at least one side wall connecting the front wall with the back wall. The front wall, the back wall and the at least one side wall defining a battery compartment. A front portion is configured to couple with the front wall of the base portion and a rear portion is configured to connect with the back wall of the base portion, wherein the base portion is cast as a single component.

### CROSS REFERENCE TO RELATED INVENTION

This application is based upon and claims priority to, under relevant sections of 35 U.S.C. § 119, Chinese Patent Application No. 201610833556.8, filed Sep. 20, 2016, the entire contents of which are hereby incorporated by reference.

### BACKGROUND

The invention relates to an industrial truck with a multiple-part vehicle frame as well as a group of industrial trucks with such multiple-part vehicle frames.

The vehicle frame of an industrial truck serves as its skeletal structure. It supports all further vehicle components such as for example the mast, the drive train, the power and control components, the hydraulics, the wheels as well as, if applicable, a counterweight. Reaction forces occurring during the operation of the industrial truck, such as during acceleration or deceleration of the industrial truck and in particular during the lifting and transporting of loads, are directed mainly into the vehicle frame. Thus, the vehicle frame must have a high stability.

Conventional vehicle frames for industrial trucks normally consist of welded parts, such as welded-together steel and/or aluminum profiles. The vehicle frames thereby differ depending on the demands placed upon the industrial truck. For example, the design of the vehicle frame can be dependent on the type and length of the industrial truck or on the size of the battery used. Normally, all vehicle components are integrated directly in the vehicle frame. Vehicle components such as the hydraulic tank and controls are hereby usually screwed on while individual components of the vehicle frame are welded together. Changes to the configuration of the industrial truck (i.e., the vehicle components) are thus hardly possible after production begins. The adjustment of the vehicle frame for the individual vehicle components also leads to a high variety. For example, a different vehicle frame is to be used for each battery size. Moreover, a finished vehicle frame is very complex to store. For this, separately developed attachments are normally provided for each frame version, which is expensive and takes up a lot of storage space.

A component group for the production of substructures of industrial trucks is known from DE 10 2007 037 098 A1. The component group provides a combination of different substructure frames adjusted for specific battery sizes with different substructure counterweights. The substructure counterweights have different steering apparatuses. It should thus be made possible to use the same substructure frame for three-wheeled vehicles as well as for four-wheeled vehicles. However, the modular construction of the substructures reduces the stability of the substructure.

### BRIEF SUMMARY OF THE INVENTION

The object of the invention is to provide an industrial truck with a multiple-part vehicle frame, which has a high stability and can be assembled easily.

The object is achieved according to the invention by an industrial truck with a multiple-part vehicle frame. In an embodiment, the vehicle frame comprises a base element (or base portion), which is produced as a one-piece cast part. The base element in turn comprises a front wall, a back wall lying opposite the front wall, at least one side wall connecting the front wall with the back wall as well as a battery compartment. Furthermore, the vehicle frame comprises a front element (or front portion) connectable with the front wall of the base element and a rear element (or rear portion) connectable with the back wall of the base element.

Thus, a modular construction of the vehicle frame of the industrial truck is achieved. The front element, the base element as well as the rear element of the vehicle frame can be produced or respectively assembled independently of each other. This simplifies and accelerates the production and in particular the installation of the vehicle frame. In addition, the combination of different base elements with different front elements and/or different rear elements is thus enabled. Thus, for example, a front element can be designed for use with a plurality of base elements. The plurality of base elements can for example comprise base elements, which have different battery compartments for accommodating batteries with different capacities. The size, in particular the length, of the battery compartment of a base element can be adjusted for the size of the battery to be accommodated. The base elements can also differ in their suitability for removal or installation of the battery. The base element can be configured for example such that a removal or an installation of the battery is possible either to the side or upwards out of the industrial truck. The base element can also be configured for the removal or installation of a battery from above as well as to the side. Through the use of a cross-variant front element, a reduction in the internal variety can be achieved with a simultaneously high variety of industrial truck varieties. The individual elements of the vehicle frame can thus be stored easier.

The base element, the front element as well as the rear element can be interconnected in a detachable manner. For this, the individual elements of the vehicle frame can have connection holes for accommodating screw connections or bolts. The rear element can also have a wheel recess for the arrangement of at least one rear wheel. For example, the rear wheel can be a rotatably mounted wheel, in particular a mounted wheel configured to rotate 360° about an axis. A driven wheel can also be provided, wherein the drive motor driving the wheel can also be accommodated in the rear element.

In an embodiment, the base element is produced as a one-piece cast part. The casted base element has a particularly high stability. The largest portion of the reaction forces occurring during the operation of the industrial truck is directed into the base element, which withstands the forces particularly well as a cast part. In an advantageous manner, the casted base element is also produced more precisely and with less deviation from the specified dimensions than welded frame elements. The connection holes of the base element are preferably machine-bored and thus have a particularly small deviation from the specified dimensions. The casted base element can thus for example be more reliably connected with the front element and/or with the rear element, since the connection holes used for this can be matched up in a considerably more exact and reliable manner. A high stability and rigidity of the vehicle frame is achieved through the casted base element despite the modular construction. The base element can be produced for example as a one-piece cast part from an iron alloy, in particular from cast iron. The use of a casted base element generally leads to a higher weight of the vehicle frame than in the case of the use of welded parts, which can however advantageously serve as a (further) counterweight to a load to be lifted by the industrial truck.

In an embodiment, the base element has at least one upper opening and one lateral opening so that a battery can be installed laterally and/or from above into the base element and removed from the base element. It is thus no longer necessary to provide base elements that enable a removal or respectively an installation of the battery upwards or to the side. This enables a further reduction in the variety. The integrity of the base element can be impacted by the provision of two openings. Thus, the production of the base element as a cast part is of particular importance. The casted base element has a sufficiently high rigidity in order to ensure a reliable operation of the industrial truck while simultaneously installing and removing the battery upwards as well as to the side. According to another embodiment, the base element may also have a floor with battery contact surfaces and a lower opening. Through a third hole provided in the floor of the base element, a battery received in the base element can be lifted from below and thus particularly easily removed from above or laterally out of the industrial truck. The installation of the battery is thus also facilitated. In particular, a removal or respectively installation of the battery can take place with a fork lift or a lift truck. The casted base element hereby has a sufficiently high rigidity in order to ensure reliable operation of the industrial truck despite the three openings in the base element.

In an embodiment, the rear element may comprise a counterweight. The counterweight can, in the case of counterbalanced trucks, balance the industrial truck during transport and during the lifting of loads. The counterweight can also have connection holes for connection with the rear wall of the base element. The counterweight can thus be connected in a detachable or non-detachable manner with the base element in a simple and reliable manner, for example via screw connections or bolts. The counterweight can also have a wheel recess for the arrangement of at least one rear wheel. The rear wheel can be a steered wheel, in particular a mounted wheel configured to rotate 360° about an axis. A driven wheel can also be provided, wherein the drive motor driving the wheel can also be accommodated in the rear element.

According to a further design, the base element has on its front wall at least two bearing means for the attachment respectively of one tilting cylinder. The bearing means are produced together with the base element as a one-piece cast part. The bearing means can comprise two bearing bars arranged on the front wall and protruding from the front wall in the direction of the front element. The bearing bars can comprise respectively an opening for receiving respectively one tiling cylinder. The tilting cylinders can be attached respectively with one end on the bearing means. For example, the tilting cylinders can be connected with the bearing bars of a bearing means via a screw connection or via a bolt connection. The other end of the tilting cylinders can be connected with a vehicle mast, in particular a lifting mast. The tilting cylinders can hereby reach through the openings provided in the front element. A bottom end of the mast can be mounted either on the front element or on the base element. The front element or respectively the base element can have corresponding bearings means for said mounting. The tilting cylinders enable the tilting of a mast connected with the tilting cylinders, whereby among other things the receiving and delivery of products is facilitated.

In an embodiment, the front element has openings for mounting a front wheel axle. The front element can also have at least one, in particular two, wheel boxes for receiving at least one, in particular, two front driver wheels. At least one drive motor for driving the at least one drive wheel can also be accommodated in the front element.

In another embodiment, the front element may have a bearing means for mounting a mast. A mast of the industrial truck can thus be connected with the vehicle frame. The bearing means can have at least two bearing openings, which can be brought to engage with at least two pins on a bottom end of the mast. According to another embodiment, the front wall of the base element has a bearing means for mounting a mast, wherein the bearing means are produced together with the base element as a one-piece cast part. The mast can thus be provided to be mounted directly on the casted base element. The reaction forces occurring from the operation of the mast can thus be directed directly into the base element without having to have been previously received by the front element. Accordingly, a particularly high stability of the industrial truck is hereby attained. In another embodiment, the bearing means may comprise two protruding support arms, each of which have bearing openings for mounting the mast on an end facing away from the front wall. This design permits a simple attachment of the mast and is also very stable and rigid. The support arms preferably have a triangular shape, protrude perpendicularly from the front wall and extend parallel to each other in the direction of the front element. This configuration of the support arms is particularly stable. The mast can be in particular a lifting mast.

In a further embodiment, the industrial truck comprises a side element (or side portion) connectable with the front element and/or the base element. According to the invention, the side element can be produced independently of the front element, the base element and the rear element. The side element can have connection holes for connection with the front element and/or the base element. The side element can be connectable in a detachable manner, in particular via a screw connection or a bolt connection, with the front element and/or the base element. The side element may be disposed on the side wall of the base element. The side element and the side wall of the base element may define a receiving area for receiving vehicle components of the industrial truck. The side element can hereby extend along the entire length of the side wall of the base element. The length of the side element can thus be dependent on the size of the used battery. The side element serves to receive vehicle components. For example, power and control components of the industrial truck can be accommodated in the receiving area of the side element. However, hydraulic components, such as a hydraulic tank for hydraulic liquids, may be accommodated in the receiving area. These hydraulic components are responsible in particular for the lifting movement of the mast. Through the modular design of the vehicle frame, the side element can also be mounted and assembled easily.

Depending on the vehicle variant, for example depending on the battery used, a side element of the appropriate length can be provided. The side element can be produced and stored as a module together with the vehicle components to be accommodated in the receiving area. According to an embodiment, the side element has a mounting plate for receiving further vehicle components, such as power and/or control components. The side element can thus serve to accommodate a plurality of vehicle components, in particular hydraulic components as well as power and/or control components. The mounting plate can be arranged above the receiving area and the side wall of the base element can be open at the level of the mounting plate. When the base element and side element are in the assembled state, vehicle components arranged on the mounting plate can thus be connected in a simple manner with a battery located in the battery compartment. The side element can form a part of the body of the industrial truck. The side element enables a multiple-part vehicle frame, which can be prefabricated in a particularly simple manner. A plurality of vehicle components necessary for the operation of the industrial truck can be accommodated in the side element in a simple manner. Such side elements can be stored in a prefabricated manner and lead to a particularly simple and efficient assembly of the industrial truck.

The invention also relates to a group of industrial trucks with a multiple-part vehicle frame according to the invention, wherein at least two industrial trucks have respectively the same front elements and different base elements. It can thus be provided that a front element variant is provided and suitable for use for a plurality of vehicle variants. The vehicle variants can differ for example in the size or respectively capacity of the battery used. The base elements of the vehicle frames can be adjusted for these different batteries. In particular, the different base elements of at least two industrial trucks can be designed to accommodate different batteries. A side element may be provided and can also be adjusted for the corresponding vehicle variant, in particular for the battery used. A plurality of variant-specific base elements and/or side elements can thus be provided, all of which are compatible with a cross-variant front element. A plurality of variant-specific or cross-variant rear elements can also be provided. These rear elements can differ for example in the size or respectively dimension of their potentially provided counterweights. For example, depending on the battery used or the mast used, another rear element can be provided. The rear elements can also differ through a different number of wheels. The front elements can also be designed in particular for receiving and attaching a certain mast variant or also several different mast variants. The base elements can also be configured to receive or couple to a certain mast variant or several different mast variants. According to a further embodiment, the different base elements of the at least two industrial trucks may have different lengths for receiving batteries with different sizes or respectively capacities.

### BRIEF DESCRIPTION OF THE DRAWINGS

The invention is explained below using several exemplary embodiments. The figures show the following:

FIG. 1 illustrates a perspective view of an embodiment of a front element, a base element, and a rear element of a vehicle frame of an industrial truck;

FIG. 2 illustrates a top plan view of the base element of the vehicle frame from FIG. 1;

FIG. 3 illustrates a perspective view of the base element of the vehicle frame from FIG. 1 receiving a battery;

FIG. 4 illustrates a perspective view of an embodiment of a base element of the vehicle frame with a bearing means configured to mount a mast;

FIG. 5 illustrates a perspective view of the base element from FIG. 4;

FIG. 6 illustrates an exploded view of the vehicle frame from FIG. 1;

FIG. 7 illustrates an exploded view of the front element, base element, and side element from FIG. 6;

FIG. 8 illustrates an exploded view of the front element, base element and side element from FIG. 6;

FIG. 9 illustrates a perspective view of an embodiment of the front element, the base element, and the rear element in an assembled state as well as the side element;

FIG. 10 illustrates a perspective view of an embodiment of the front element, the base element, the rear element, and the side element in an assembled state.

### DETAILED DESCRIPTION OF THE INVENTION

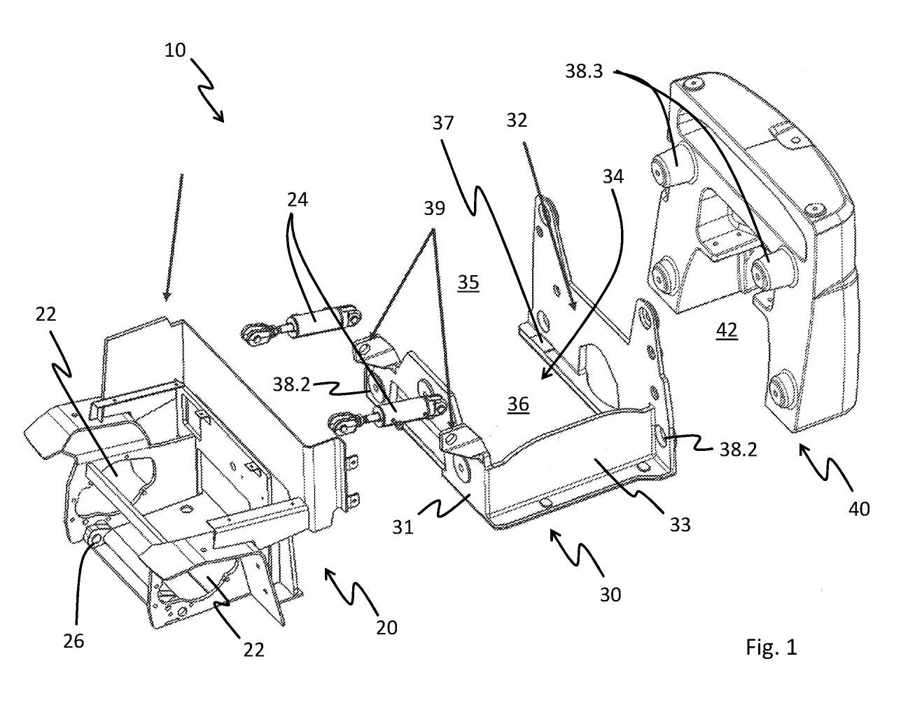

FIG. 1 shows the individual elements of the multiple-part vehicle frame for an industrial truck according to the invention. The vehicle frame 10 comprises a front element 20, a base element 30 as well as a rear element 40.

The front element 20 has as bearing means for a vehicle mast two bearing openings 26, which can be brought to engage with the bottom end of the mast. The front element 20 also has wheel motor receivers 22 for mounting a front wheel axle.

The base element 30 comprises a front wall 31, a back wall 32 lying opposite the front wall 31 as well as a side wall 33, which interconnects the front wall 31 and the back wall 32. A battery compartment 34 is formed by the front wall 31, the back wall 32 as well as the side wall 33. The floor of the base element 30 has an opening 36 as well as a narrow border surrounding the opening 36. The narrow border has battery contact surfaces 37. The base element 30 is also open towards the top in order to enable the removal and installation of a battery upwards and also has a lateral opening 35 in order to enable the removal and installation of the battery to this side. Two bearing means 39, each of which serves to attach one tilting cylinder 24, are provided on the front wall 31 of the base element 30.

Still referring to FIG. 1, the rear element 40 mainly consists of a counterweight with a wheel recess 42, which serves to receive a rear wheel. A drive motor of the rear wheel can also be accommodated in the wheel recess 42.

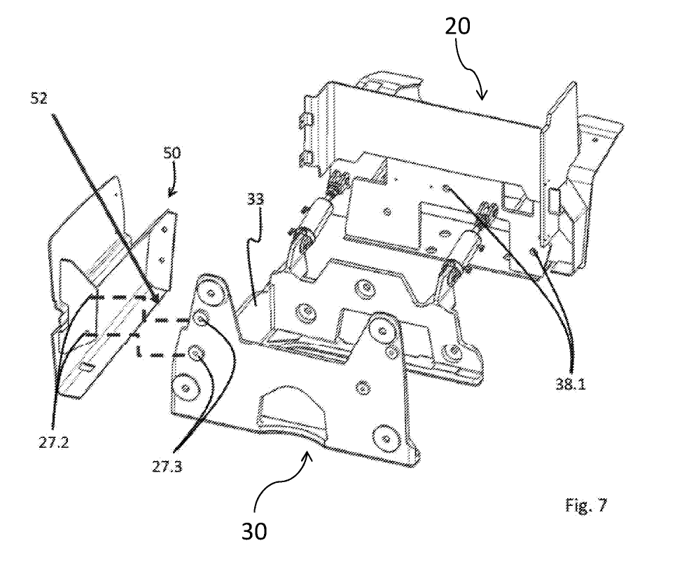

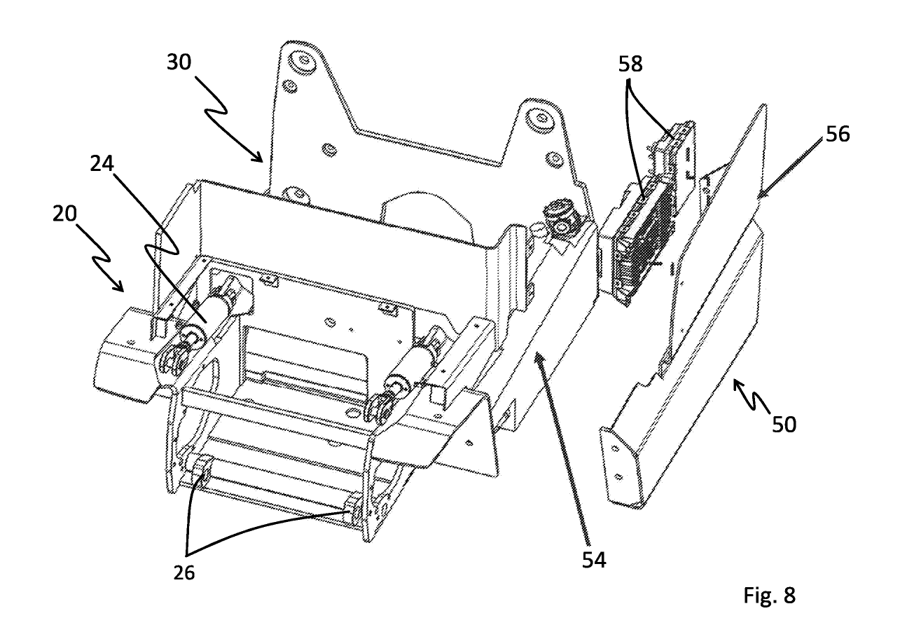

As shown in FIG. 1, the base element 30 can be connected with connection holes 38.1 (FIG. 7) provided in the back side of the front element 20 via connection holes 38.2 in its front wall 31. The connection holes 38.2 provided on the back wall 32 of the base element serve to connect with the rear element 40 via the connection holes 38.3. When the vehicle frame is in the assembled state, the tilting cylinders 24 protrude into the front element 20 through openings provided in the back side of the front element, as can be seen in FIG. 8.

As shown in FIG. 8, the mast of the industrial truck is hereby connected with a bottom end with the bearing openings 26 of the front element 20 and with a mast area lying above this with the tilting cylinders 24. The mast is thus rotatably mounted on the front element 20 via the bearing openings 26 and can be tilted forwards and backwards via a movement of the tilting cylinder 24.

The reaction forces occurring during the operation of the industrial truck are mainly directed into the base element 30 due to the design of the vehicle frame 10. The base element 30 is produced as a one-piece cast part and is thus particularly suitable for receiving these reaction forces. Despite its U-shaped design and the plurality of openings, the base element 30 is thus rigid enough to sufficiently stabilize the industrial truck.

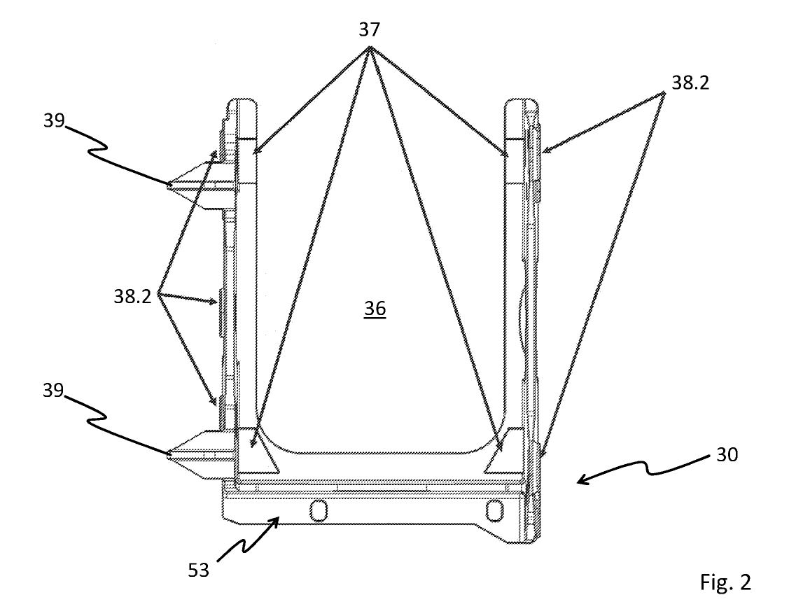

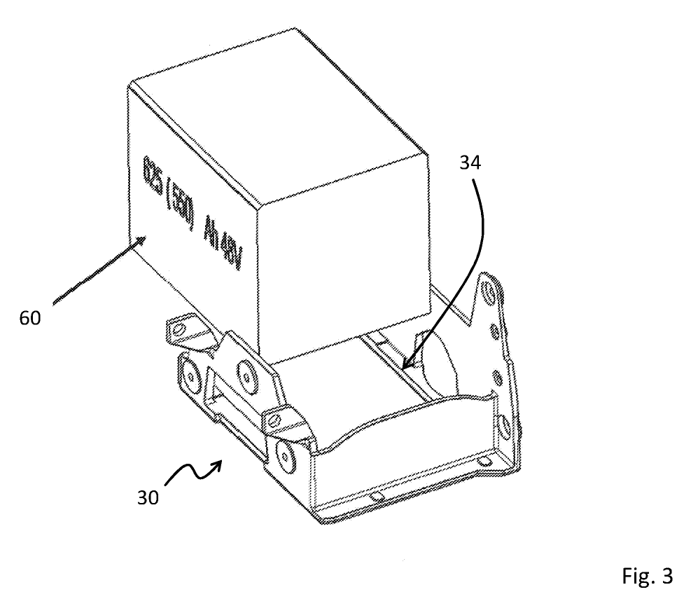

As can be seen in FIG. 2, the base element 30 has on its front wall 31 two bearing means 39, which, as mentioned, serve to attach the tilting cylinders 24 (FIGS. 1, 4, 6-10). These bearing means 39 are produced together with the base element 30 as a one-piece cast part. The bearing means 39 comprise bearing bars each with an opening for connecting with the tilting cylinders 24 (FIGS. 1, 4, 6-10). A particularly high stability of the industrial truck is achieved through the attachment of the tilting cylinders 24 (FIGS. 1, 4, 6-10) on the bearing means 39 directly to the base element 30. The reaction forces occurring through the tilting of the mast are directed directly into the base element 30 via the tilting cylinders 24 (FIGS. 1, 4, 6-10). The floor of the base element 30 has a large opening 36, which makes it possible to lift from below a battery 60 (FIG. 3) arranged in the receiving area of the base element 30 and then to remove it laterally or upwards out of the base element 30. The battery 60 (FIG. 3) can consequently be removed and installed for example in a simple manner by a forklift or a lift truck. In the installed state, the battery 60 (FIG. 3) is mounted on battery contact surfaces 37, which are raised with respect to a border of the floor of the base element 30.

FIG. 3 shows how a battery 60 is installed in or respectively removed from the battery compartment 34 of the base element 30.

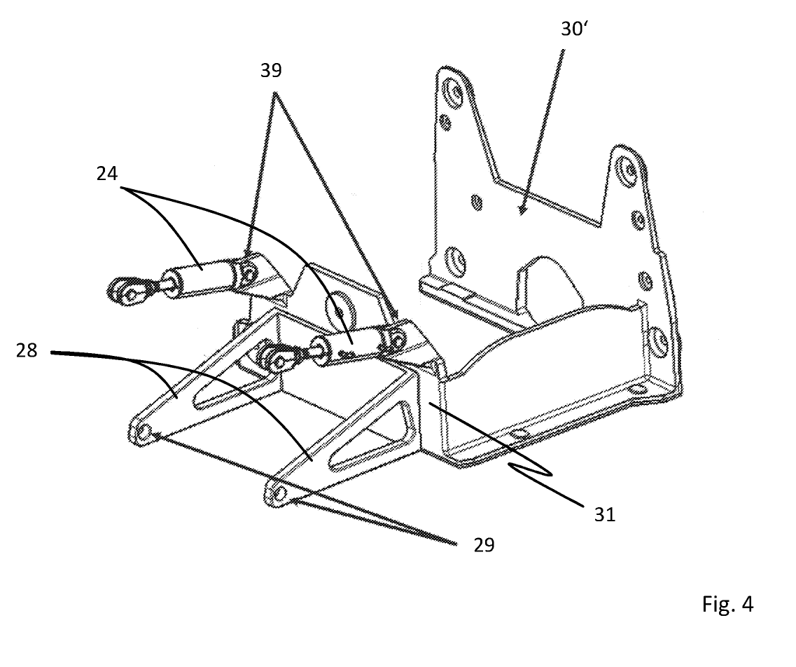

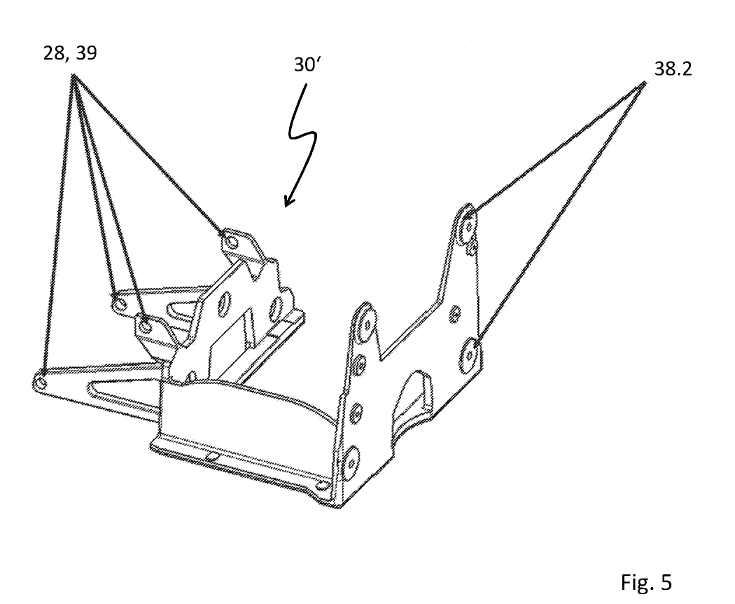

FIGS. 4 and 5 show a base element 30′ in a second embodiment. This base element 30′ comprises two support arms 28, which are designed on the front wall 31 (FIG. 4) of the base element 30′, as bearing means for mounting the mast. The support arms 28 each have a bearing opening 29 (FIG. 4) for mounting the bottom end of a mast. The support arms 28 are produced together with the complete base element 30′ as a one-piece cast part. A mounting of the mast thus takes place via the bearing openings 29 (FIG. 4) of the support arms 28 as well as via the tilting cylinders 24 (FIG. 4) and the bearing means 39 directly on the base element 30′. In contrast to a mounting of the mast on the front element 20 (FIGS. 1, 6-10), a particularly high stability of the industrial truck thus results. In this design, a front element 20 (FIGS. 1, 6-10) to be connected with the front wall 31 (FIG. 4) of the base element 30′ is freed for the most part from the reaction forces occurring during the operation of the industrial truck. Apart from the support arms 28, the base element 30′ from FIGS. 4 and 5 is the same as the base element 30 from the rest of the figures. In particular, the base element 30′ shown in FIGS. 4 and 5 is connectable with the front element 20 (FIGS. 1, 6-10) and the rear element 40 (FIGS. 1, 6, 9, 10). The base element 30′ hereby also has connection holes 38.2 (FIG. 5).

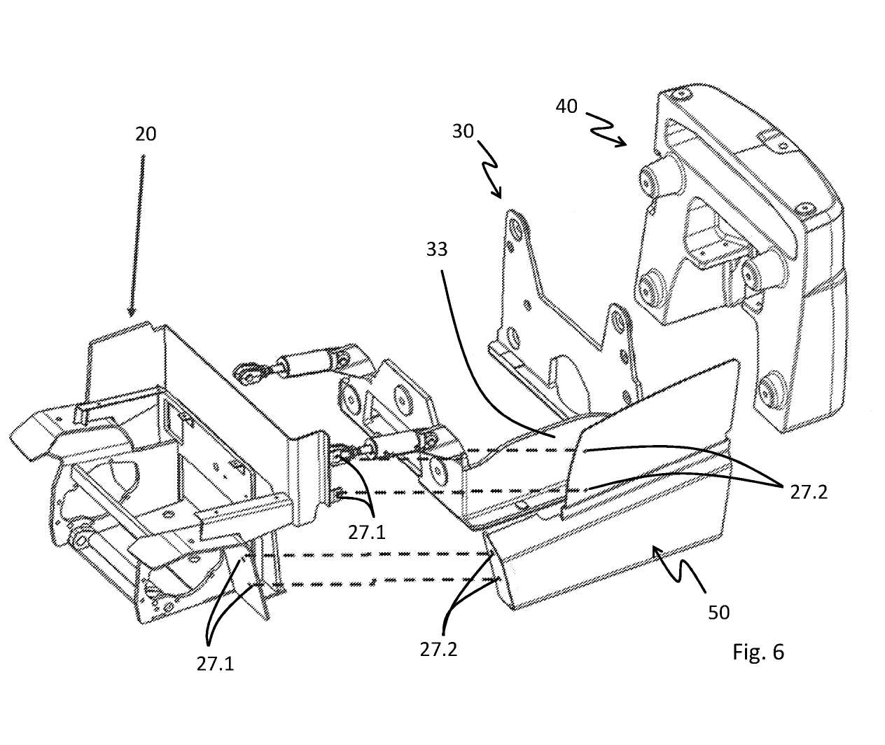

FIGS. 6 to 9 show the base element 30 together with a side element 50. The side element 50 is connectable with connection holes 27.1 (FIG. 6) of the front element 20 via connection holes 27.2 (FIGS. 6-7) and with the base element 30 via connection holes 27.3 (FIG. 7) of the base element 30. Referring to FIG. 7, when connected with the base element 30, the side element 50 is arranged on the side wall 33 of the base element 30 such that a receiving area 52 is formed. This receiving area 52 present between the side wall 33 of the base element 30 and the side element 50 serves to accommodate various vehicle components. As can be seen in FIG. 8, this can be a hydraulic tank 54, for example.

Referring to FIG. 1, the back wall 32 of the base element 30 protrudes slightly over the side wall 33. Adjacent to an outside of the side wall 33 lying opposite the battery compartment 34, a bar 53 is arranged, which is also connected with the part of the back wall 32 of the base element 30 protruding over the side wall 33. For one, this increases the stability. Referring of FIG. 8, the bar 53 can also serve as a rest for the hydraulic tank 54. The hydraulic tank 54 is adjusted for the shape of the lower area of the side element 50 so that the receiving area 52 in the assembled state of the side element 50 is mainly completely filled up by the hydraulic tank 54.

As shown in FIG. 8, the side element 50 also has a mounting plate 56, which serves to receive further vehicle components 58. These vehicle components can be in particular power and/or control components. Referring to FIGS. 1 and 7, the side wall 33 of the base element 30 is designed low such that the vehicle components 58 (FIG. 8) mounted on the mounting plate 56 (FIG. 8) above and beyond the side wall 33 can be connected with a battery located in the battery compartment 34 (FIGS. 1 and 3).

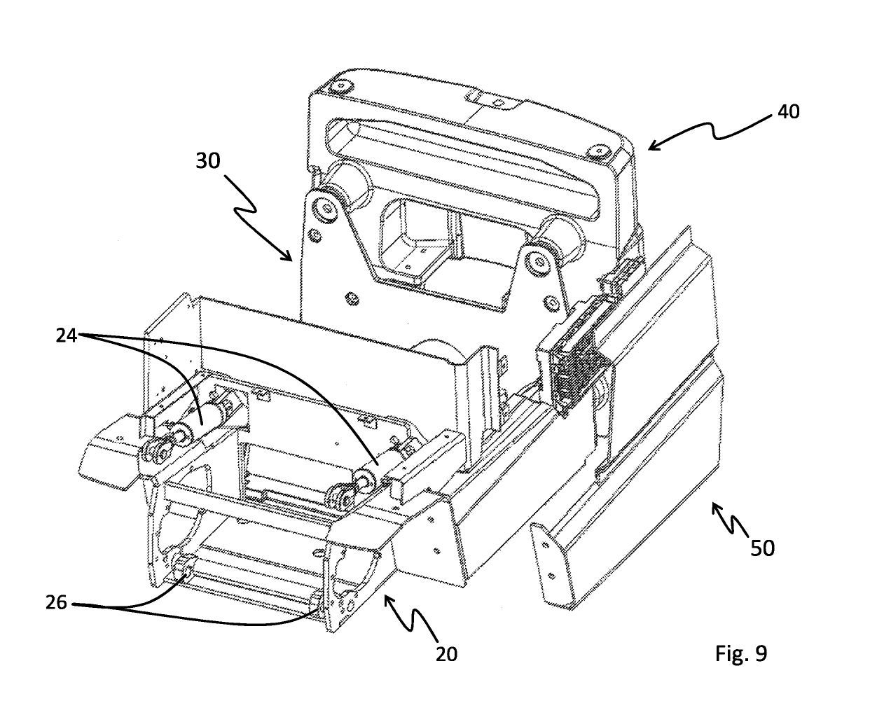

FIG. 9 shows the base element 30 together with the front element 20 and the rear element 40 in an assembled state. The side element 50 can hereby also be attached to the base element 30 or respectively the front element 20. The tilting cylinders 24 may protrude through openings in the front element 20 are easy to see. As shown, a vehicle mast with the bearing openings 26 of the front element 20 as well as with the tilting cylinders 24 fastened on the base element 30 is attached. Reaction forces occurring while the vehicle is operating are partially directed into the base element 30 via the front element 20.

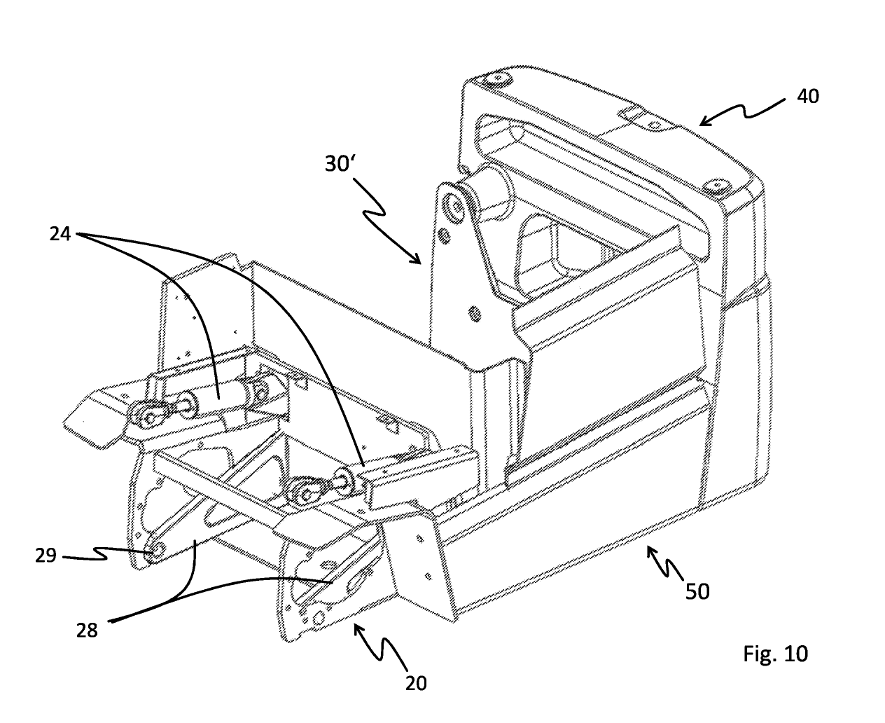

FIG. 10 shows the base element 30′ together with the front element 20, the rear element 40 as well as the side element 50 in an assembled state. The tilting cylinders 24 may protrude through openings in the front element 20. A vehicle mast with the bearing openings 29 of the support arms 28 of the base element 30′ as well as with the tilting cylinders 24 also fastened on the base element 30′ is attached. This design is particularly stable since the vehicle mast is connected directly with the base element 30′ produced as a cast part. Reaction forces occurring while the vehicle is operating are thus mainly directed directly (i.e., bypassing the front element 20) into the base element 30′.

### PARTS LIST FOR FIGS. 1-10

10 Vehicle frame
20 Front portion
22 Wheel motor receivers
24 Tilting cylinder
26 Bearing openings
27.1 Connection hole
27.2 Connection hole
27.3 Connection hole
28 Support arms
29 Bearing opening
30, 30′ Base portion
31 Front wall
32 Back wall
33 Side wall
34 Battery compartment
35 Opening
36 Opening
37 Battery contact surface
38.1 Connection hole
38.2 Connection hole
38.3 Connection hole
39 Bearing means
40 Rear portion
42 Wheel recess
50 Side portion
52 Receiving area
53 Bar
54 Hydraulic tank
56 Mounting plate
58 Vehicle component
60 Battery

1. An industrial truck with a multi-part vehicle frame, the multi-part vehicle frame comprising:
a base portion comprising,
a front wall,
a back wall disposed opposite the front wall, and
at least one side wall connecting the front wall with the back wall, wherein the front wall, the back wall and the at least one side wall define a battery compartment;
a front portion configured to couple with the front wall of the base portion; and
a rear portion configured to couple to the back wall of the base portion,
wherein the base portion is cast as a single component.

2. The industrial truck according to claim 1, wherein the base portion defines at least one upper opening and at least one lateral opening configured to receive a battery, the battery being configured to be installed into and removed from the base portion laterally or from above.

3. The industrial truck according to claim 1, wherein the base portion comprises a floor with battery contact surfaces and a bottom opening.

4. The industrial truck according to claim 1, wherein the rear portion further comprises a counterweight.

5. The industrial truck according to claim 1, wherein the base portion further comprises at least two bearing means each configured to attach to a tilting cylinder.

6. The industrial truck according to claim 1, wherein the front portion comprises wheel motor receivers configured to mount a front wheel axle.

7. The industrial truck according to claim 1, wherein the front portion comprises a bearing means configured to mount a mast.

8. The industrial truck according to claim 1, wherein the front wall of the base portion comprises a bearing means configured to mount a mast, wherein the bearing means is formed as a single component with the base portion.

9. The industrial truck according to claim 8, wherein the bearing means comprises two protruding support arms, and wherein each of the two protruding support arms define bearing openings configured to mount the mast on an end facing away from the front wall.

10. The industrial truck according to claim 9, wherein each of the two protruding support arms are substantially triangular in shape and configured to protrude perpendicularly from the front wall and extend parallel to each other in a direction of the front portion.

11. The industrial truck according to claim 1, further comprising a side portion configured to couple to at least one of the front portion and the base portion, wherein the side portion is formed as a separate component from the front portion, the base portion, and the rear portion.

12. The industrial truck according to claim 11, wherein the side portion is configured to detachably couple to at least one of the front portion and the base portion.

13. The industrial truck according to claim 12, wherein the side portion is disposed on the side wall of the base portion, wherein the side portion and the side wall of the base portion define a receiving area configured to receive vehicle components.

14. A group of industrial trucks according to claim 1, wherein at least two of the group of industrial trucks each comprise a same front portion and different base portions.

15. The group of industrial trucks according to claim 14, wherein the different base portions of the at least two of the group of industrial trucks comprise different lengths that are configured to receive batteries of different sizes.

16. The group of industrial trucks according to claim 14, wherein the different base portions of the at least two of the group of industrial trucks comprise different lengths that are configured to receive batteries of different capacities.
